(19) United States
(12) Patent Application Publication
(10) Pub. No.: US 2004/0188110 A1
(43) Pub. Date: Sep. 30, 2004

(54) Tool assembly

(76) Inventor: Dick Liao, Bridgewater, MA (US)

Correspondence Address: FISH & RICHARDSON PC, 225 FRANKLIN ST, BOSTON, MA, 02110, US

(21) Appl. No.: 10/358,051

(22) Filed: Feb. 4, 2003

(51) Int. Cl. A01B 1/00

(52) U.S. Cl. 172/378

(57) ABSTRACT

A tool assembly includes a handle, a main tube and an implement. The main tube has a slot at one end and a detent proximate to the slot. The detent is movable between an extended position and a retracted position and is biased toward the extended position. The handle has a handle tube. The implement includes an implement tube. Both the handle tube and the implement have a hole and a crossmember fixed onto the inner surface of the implement tube or the handle tube. The handle tube, the main tube, and the implement tube are so configured that when the main tube is inserted into the implement tube or the handle tube, the detent is secured within the hole of the implement tube or the handle tube and the crossmember of the implement tube or the handle tube rests against the slots of the main tube.

### BACKGROUND OF THE INVENTION

The invention relates to a tool assembly, especially a tool assembly for loosening and cultivating soil.

Assembled tools with two or more parts connected together are designed to save space and cost for shipment or to be easily repaired and replaced. The connecting points or area around are usually more vulnerable than the rest parts of the assembly as they bear stress from the connected parts and transfer force applied to the tool assembly during use. In general, a tool for certain purpose constantly receives stress at the same direction or about the same local area on the tool. When the connecting points are all positioned at such a same direction or at about same local area, they are easily worn out. This results in that a tool assembly is not as durable and efficient as an integrated tool.

### SUMMARY OF THE INVENTION

The invention features a tool assembly for loosening and cultivating soil as durable and efficient as an integrated tool, with reducet shipment space and cost, and easy for repair and replacement.

In one aspect, the tool assembly includes a main tube and an implement. The main tube has a slot at one end and a detent proximate to the slot. The detent is movable between an extended position and a retracted position and is biased toward the extended position. The implement includes an implement tube with an upper end and a lower end. At the upper end, there is a hole and a crossmember fixed onto the inner surface of the implement tube. The main tube and the implement tube are so configured that when the main tube is inserted into the implement tube, the detent is secured within the hole of the implement tube and the crossmember rests against the slot. Thus, the main tube is securely connected to the implement tube. In this aspect, embodiment may include one or more of the following. The crossmember has the central axis that is substantially perpendicular to that of the implement tube. The hole may be spaced-apart from the crossmember along the length of the implement tube, and has a central axis that is angled from the central axis of the crossmember. The crossmemeber can be tubular, rectangular, a board or any other suitable shape. In a preferred embodiment, the central axis of the hole is substantially 90 degrees from that of the crossmember.

In one embodiment, the implement is a tine as disclosed in U.S. Pat. No. 5,706,900, incorporated herewith by reference in its entirety. The main tube may have a second slot at another end and a second detent proximate to the second slot. The tool assembly may also include a handle as disclosed in U.S. Pat. No. 5,706,900, incorporated by reference in its entirety. The handle has a handle tube with a crossmember fixed onto an inner surface. The main tube and the tube are so configured that when the main tube is inserted into the handle tube, the second detent is secured within the hole of the handle tube, the crossmember of the handle tube rests against the second slot. Therefore the main tube is securely connected to the handle tube.

In this aspect, embodiment may include one or more of the following. The axis of the crossmember of the handle tube is substantially perpendicular to that of the handle tube. The hole of the handle tube is spaced-apart from the crossmember along the length of the handle tube. The hole of the handle tube has a central axis that is angled from the central axis of the crossmember of the handle tube. In a preferred embodiment, the central axis of the hole is substantially 90 degrees from that of the crossmember.

The implement tube and the handle tube may both further include a second hole symmetrically positioned to the crossmember as opposed to the first hole. The first hole and the second hole each share a central axis that is substantially perpendicular to that of the implement tube or the handle tube and to that of the crossmembers. In a preferred embodiment, one of the axis of the holes and the crossmembers of the handle is substantially perpendicular to the axis of the middle section of the handle. The crossmember of the implement tube is positioned between the first hole and the second hole, and the lower end of the implement tube. The crossmember of the handle tube is positioned between the first hole and the second hole, and the upper end of the handle tube.

The first detent and the second detent of the main tube may be biased by a reed. The reed may have one end connected with the inner surface of the main tube, the other end fixed onto each of the first detent or the second detent. The detent may also include a detent hole so that the detent can be readily moveable between the retracted and the extended position through the main tuber.

In a different aspect, the tool assembly features a handle for imparting torque about the longitudinal axis of a connected tube of a tool assembly. The handle can be any type of the handles disclosed in the U.S. Pat. No. 5,706,900 or otherwise known in the art. The handle includes a handle tube. At the a lower of the handle tube, there are a hole and a crossmember fixed onto an inner surface of the handle tube, and an upper end connected to the handle portion In this aspect, preferably, the hole has a central axis that is substantially 90 degrees from the axis of the crossmember. The axis of the crossmember is substantially perpendicular to that of the handle tube. The hole can be spaced-apart from the crossmember along the length of the handle tube. The handle tube includes a second hole. The first hole and the second hole of the handle tube each share a central axis that is substantially perpendicular to that of the handle tube and that of the crossmember of the handle tube.

In one embodiment of this aspect, the handle tube may have a slot at a lower end and a detent proximate to the slot. The detent can be moveable between an extended position and a retracted position and is biased toward the extended position. In a preferred embodiment, the slot has an axis that is substantially perpendicular to that of the handle tube and that of the detent. The detent is spaced-apart from the slot along the length of the handle tube. The slot has a central axis that is substantially perpendicular to that of the handle tube.

In another aspect, the invention features a tube having a slot at a first end and a detent proximate to the slot. The detent can be moveable between an extended position and a retracted position and is biased toward the extended position. Embodiment may include one or more of the following. The tube may also have a second slot at the second end and a second detent proximate to the second slot. The second detent can be movable between an extended position and a retracted position, and is biased toward the extended position. In a preferred embodiment, the first slot and the second slot each share a axis that is substantially perpendicular to that of the tube and that of the detent. The detents are spaced-apart from the slot along the length of the tube. The axis of the detents is substantially 90 degrees from that of the slots.

Another embodiment of this aspect features a tube. The tube includes a first end, a second end, and a longitudinal axis. The tube has a hole at a first end and a crossmember fixed onto an inner surface of the tube. The tube can also have a second hole at the second end and a second crossmember fixed onto an inner surface of the tube. The second hole is spaced-apart from the crossmember along the length of the tube. In a preferred embodiment, the first hole and the second hole each share a central axis that is substantially perpendicular to that of the tube and that of the crossmember of the tube. The axis of the crossmember is substantially perpendicular to that of the tube.

In this aspect, the tube can be a short tube that can be used as a cover to connect with other corresponding shaped parts of a tool assembly. The tool assembly can be assembled by connecting the parts covered by the short tubes.

In still another aspect, the invention features an implement of a tool assembly having an implement tube. The implement tube has a lower end and an upper end. At the upper end there is a hole and a crossmember fixed onto an inner surface of the implement tube. The hole can be spaced-apart from the crossmember along the length of the implement tube. There may be a second hole at the second end and a second crossmember fixed onto an inner surface of the tube. In a preferred embodiment, the axis of the crossmember is substantially perpendicular to that of the implement tube. The first hole and the second hole each share a central axis perpendicular to that of the implement tube and that of the crossmember of the implement tube. The first and the second hole are spaced-apart from the crossmember along the length of the tube.

In this aspect, the implement can be a tine as disclosed in the U.S. Pat. No. 5,706,900 or otherwise known in the art. An implement has an implement tube having a lower end and an upper end. The upper end includes a slot and a detent proximate to the slot. The detent can be moveable between an extended position and a retracted position, and biased toward the extended position. The axis of the detent can be substantially perpendicular to that of the implement tube. The detent may be spaced-apart from the slot along the length of the implement tube. The hole may have a central axis that is angled from the axis of the slot. In a preferred embodiment, the implement tube further includes a second slot at the second end and a second detent proximate to the second slot. The second detent can be moveable between an extended position and a retracted position, and biased toward the extended position. The first detent and the second detent each share a central axis that is substantially perpendicular to that of the first slot and the second slot and that of the implement tube. The first and second detents are spaced-apart from the crossmember along the length of the tube.

In still another aspect, the tool assembly that is reversed from the previous embodiment. The tool assembly includes a main tube, a tine and a handle. The tine and handle can be any type as disclosed in U.S. Pat. No. 5,706,900 or otherwise known in the art. The main tube has a first end, a second end, and a longitudinal axis. The main tube has a hole at one end and a crossmember fixed onto the inner surface of the main tube. The handle includes a handle tube having a lower end and an upper end. The lower end has a slot and a detent proximate to the slot. The implement includes an implement tube having a lower end and an upper end. The lower end has a slot and a detent proximate to the slot. The detent can be movable between an extended position and a retracted position, and biased towards the extended position. The main tube, the implement tube and the handle tube are so configured that when the tine tube and the handle tube are inserted into the main tube, the detents of the tine tube and the handle tube are secured within the first hole and the second hole of the main tube respectively, and the first crossmember and the second crossmember of the main tube rest against the slots of the tine tube and the handle tube respectively. The main tube is securely connected to the implement tube and the handle tube. In a preferred embodiment, the crossmember has a central axis that is substantially perpendicular to that of the main tube. The first hole and the second hole are spaced-apart from the crossmember along the length of the main tube. The first hole and the second hole each share a central axis that is substantially perpendicular to the axis of the main tube and the crossmember. The first detent and the second detent of the implement tube each share a central axis. The first slot and the second slot of the implement tube each share a central axis that is substantially perpendicular to that of the first slot and the second slot of the implement tube and that of the implement tube. The first detent and the second detent of the handle tube each share a central axis that is substantially perpendicular to that of the first slot and the second slot of the handle tube and that of the handle tube.

Other advantages and features of the invention will be apparent from the following description and from the claims.

### BRIEF DESCRIPTION OF THE DRAWINGS

FIG. 1 is an exploded perspective view of the tool assembly.

FIG. 2 is a perspective view of a handle of the tool assembly in FIG. 1.

FIG. 2A is a side view of the handle in FIG. 2 along line AA.

FIG. 2B is a diagrammatical partial cross-sectional view of the handle in FIG. 2A along line BB.

FIG. 3 is a perspective view of a tine of the tool assembly in FIG. 1.

FIG. 3A is a cross-sectional view of the tine of the tool assembly in FIG. 3 along line AA.

FIG. 4 is a cross-sectional detail view of the main tube of the assembled tool assembly of FIG. 1 along line A.

FIG. 4A is a top view of the main tube shown in FIG. 1.

FIG. 5 is a perspective view of an embodiment of an assembled tool assembly.

FIG. 5A is a cross-sectional detail view of the assembled tool assembly taken substantially through a plane indicated by the section line A in FIG. 5.

FIG. 6 is a perspective view of another embodiment of an assembled tool assembly.

### DESCRIPTION OF THE INVENTION

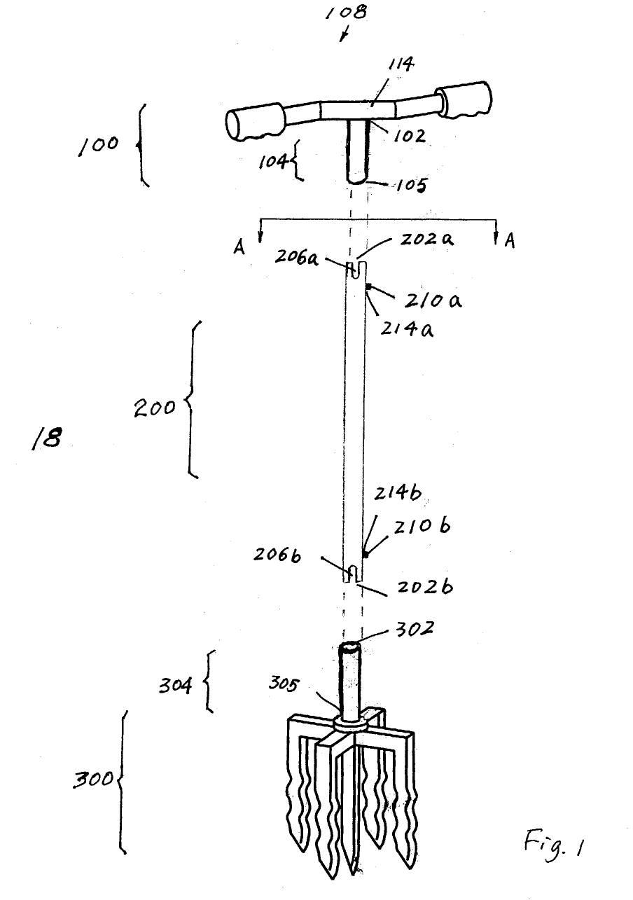

Referring to FIG. 1, an embodiment of a tool assembly 18 is shown. The tool assembly 18 includes a handle 100, a vertically disposed main tube 200 and an implement 300. The main tube 200 has two ends 202a and 202b that can be releasable connected to the handle 100 and the implement 200.

The main tube 200 can also be devised to connect various kinds of implements at one end and provide a suitable handgrip at the other end for a user to grasp the tool assembly and to apply a force to the implement 300 during operation. The implement 300 can be a tine as shown in FIG. 1, a spade, a rake, a trowel, a draw hoe, a digging fork etc.

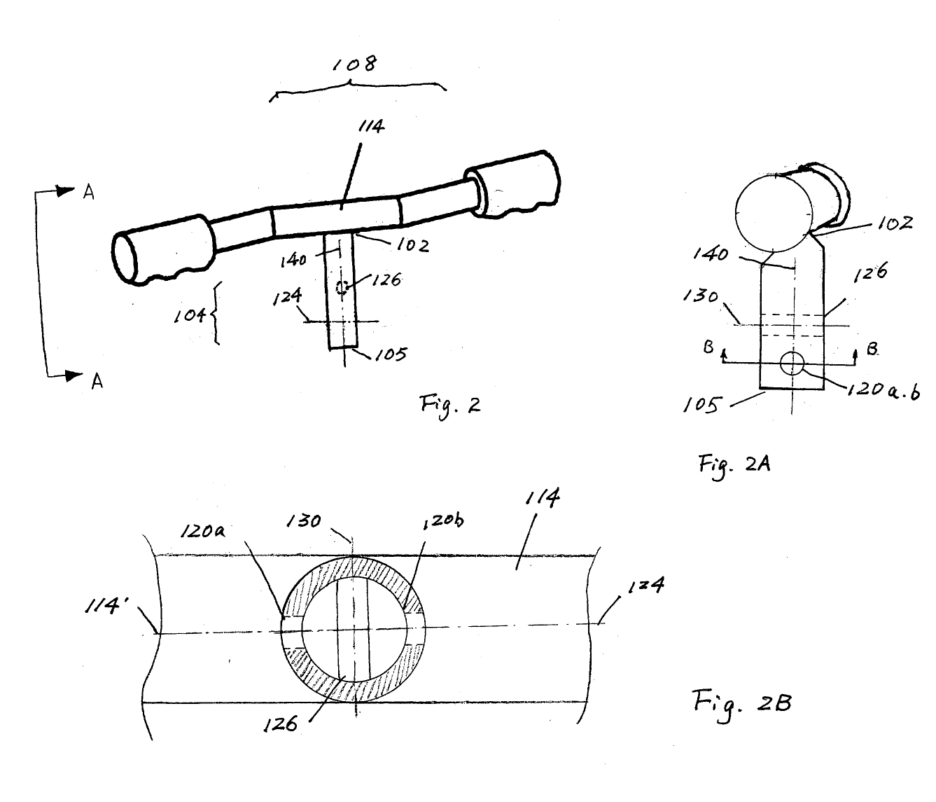

FIG. 2 illustrates an embodiment of a handle of the tool assembly. The handle 100 includes a handle tube 104 and a handle portion 108. The handle portion can be any embodiments disclosed in U.S. Pat. No. 5,706,900 or otherwise known in the art. The handle portion 108 has a middle section 114 having a central axis 114′.

Referring to FIG. 2A and 2B, extending between the inner surfaces of the hand tube 104 is a crossmember 126. In a preferred embodiment, the axis 130 of the crossmember 126 is substantially perpendicular to the central axis 114′ of the middle section 114 of the handle portion 108. The crossmember 126 is positioned such that the central axis 130 of the crossmember 126 is substantially perpendicular to a central axis 140 extending through the center of the handle tube 104. Spaced-apart from the crossmember 126 along the length of the handle tube 104 is two holes 120a and 120b. The holes 120a and 120b each share a central axis 124 that is substantially 90 degrees from the axis 130 of the crossmember 126. The central axis 124 of the holes 120a and 120b, however, can be oriented at various angles with respect to central axis 130 of the crossmember 126. The holes 120a and 120b are preferably positioned toward the lower end 105 of the handle tube 104 with respect to the crossmember 126. It should be noted that the holes 120a and 120b can also be positioned toward the handle portion 108. In other embodiments, the handle tube has a single hole or more than two holes.

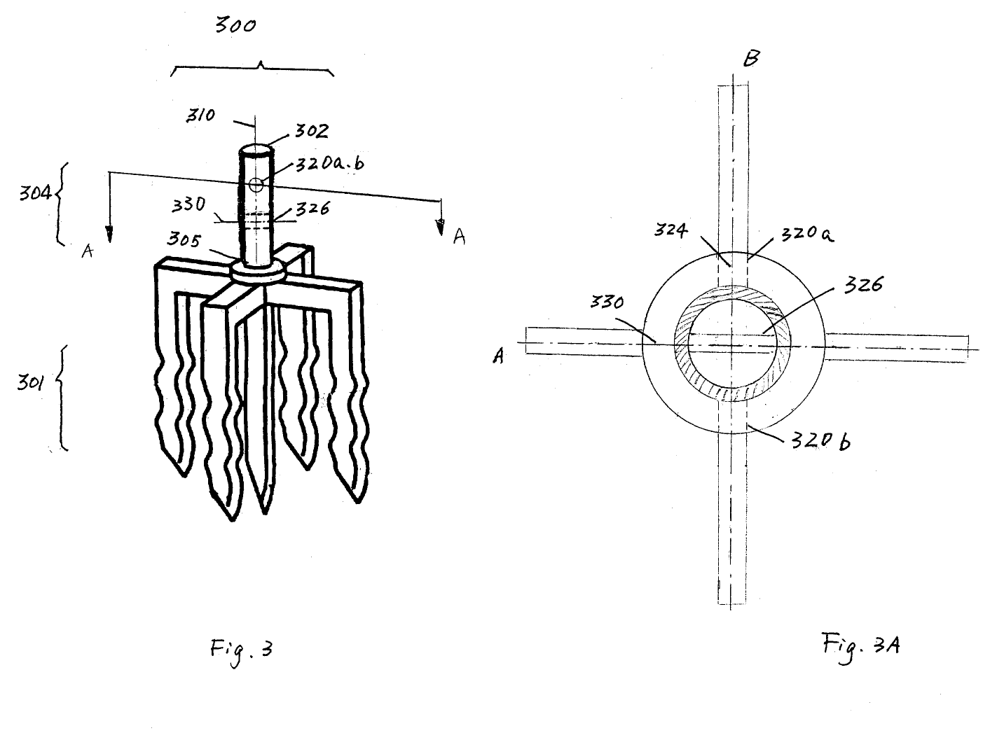

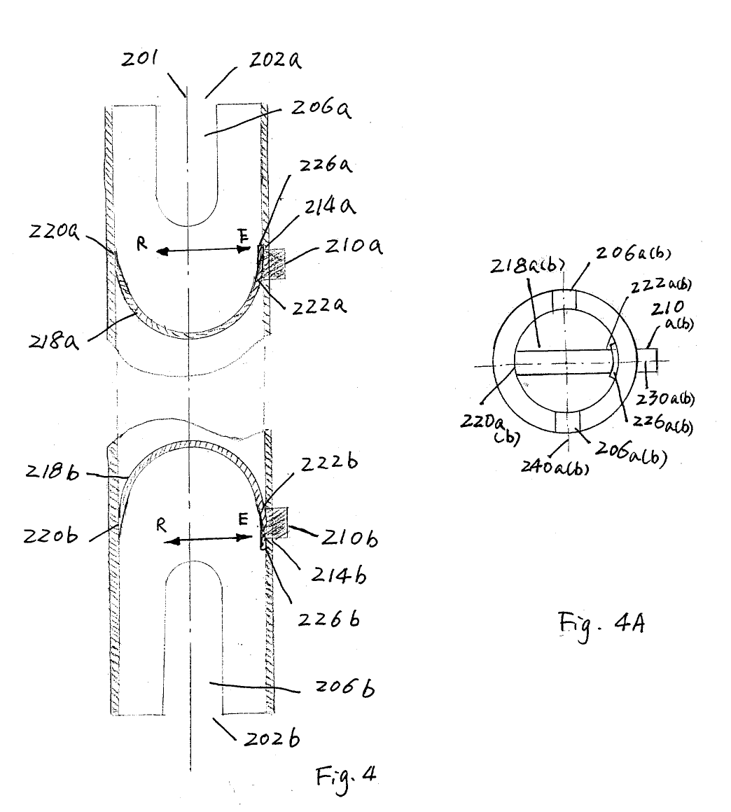

Referring to FIG. 3 and 3A, an embodiment of a tine 300 is shown. The tine 300 has a tine tube 304. A tine 301 is provided at the lower end 305 of the tine tube 304. The tine 300 can be any embodiments disclosed in U.S. Pat. No. 5,706,900.

Referring to FIG. 3A, a crossmember 326 is positioned across the inner surfaces of the tine tube 304. The central axis 330 of the crossmember 326 is preferably positioned such that the central axis 330 of the crossmember 326 is substantially perpendicular to a central axis 310 extending through the center of the tine tube 304. Spaced-apart from the crossmember 326 along the length of the tine tube 304 are two holes 320a and 320b each sharing a central axis 324. The central axis 324 of the holes 320a and 320b, can be oriented at various angles with respect to the central axis 330 of the crossmember 326. In a preferred embodiment, the angle is substantially 90 degrees from the axis 330 of the crossmember 326. The holes 320a and 320b are positioned toward the upper end 302 of the tine tube 304 with respect to the crossmember 326. However the holes 320a and 320b can also be positioned toward the tine portion 301. Preferably, the tine portion 301 has a pair of tines extending outwardly from the central axis 310 along Line A in opposite direction. Another pair of tines extends outwardly from the central axis 310 along Line B in opposite direction. Line A is substantially perpendicular to Line B. One of the axes of the crossmember 326 and hole 320 is substantially parallel with Line A. The other is substantially perpendicular to Line A, i.e. parallel with Line B. In other embodiments, there also can be a single hole or more than two holes.

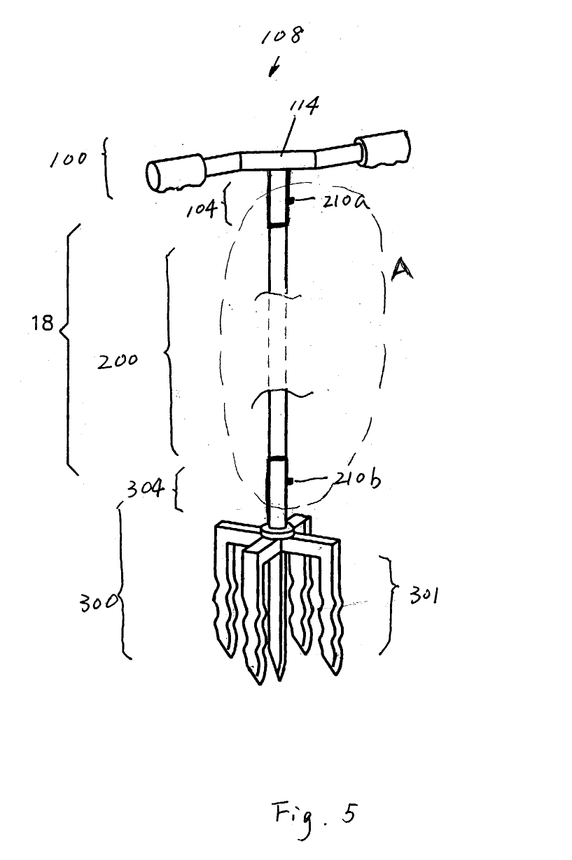

Referring to FIG. 4 and 4A regarding the main tube 200. Slot 206a is formed at one end 202a of the main tube 200. Slot 206b is formed at the opposite end 202b of the main tube 200. Detent holes 214a and 214b are positioned close to slots 206a and 206b respectively along the length of the main tube 200. Detents 210a and 210b each have a slightly smaller diameter than that of the detent holes 214a and 214b, so that they can be moved readily through the detent holes 214a and 214b between a retracted position R and an extended position E.

Preferably, the central axes 240a and 240b of the slots 206a and 206b are substantially perpendicular to a central axis 201 extending through the center of the main tube 200. Spaced-apart from the slots 206a and 206b along the length of the main tube 200 are two detents 210a and 210b each sharing a central axis 230a and 230b. The central axes 230a and 230b of the detents 210a and 210b, can be oriented at various angles with respect to the central axis 240a and 240b of the slots 206a and 206b. In a preferred embodiment, the angle is substantially 90 degrees from the axis 240a and 240b of the crossmember 206a and 206b. The detents 210a and 210b are positioned respectively away from the end 202a and 202b of the main tube 200 with respect to the slots 206a and 206b. However the detents 210a and 210b can also be positioned toward the end 202a and 202b along the main tube 200. In other embodiments, there also can be two or more detents.

The main tube 200 includes reed 218a and 218b. The detent 210a and 210b are respectively biased by the tension of the reed 218a and 218b towards the extended position E. One ends 220a and 220b of the reed 218a and 218b are connected onto the inner surface of the main tube 200. The other ends 222a and 222b are mounted onto the detent 218a and 218b. When a user presses the detent, the detent 210a and 210b can be readily moved towards the end 220a and 220b. When the reed 218a and 218b are released, they are extending outwardly from the outer surface of the main tube at the end 222a and 222b. There are portion 226a and 226b at the end of the reed 220a and 220b. The portion 226a and 226b have slightly bigger diameter than the detent holes 214a and 214b, such that the detent 210a and 210b can be stopped at the end 220a and 220b. The movement of the reeds 218a and 218b are along a direction substantially perpendicular to the central axis 201 of the main tube 200.

The reeds 218a and 218b can be substantially U shaped, semicircular or V shaped or made by any technology known in the art, as long as it provides constant pressure to the detent 210a and 210b that maintains firmly extended outwardly from the outer surface. It prevents the rattling and looseness of the connection between the detent 210a and 210b and the holes 120a and 120b of the handle tube as well as holes 320a and 320b of the implement tube, especially, when a torque is applied to about the axis of the tool assembly. If the reeds 218a and 218b is substantially V shaped, the lowest point of the V shaped reed 218a and 218b can be not on the same vertical line as the central axis of the main tube. Preferably away from the central axis along the diameter of the main tube 200 towards either of the ends 220a and 220b of the reeds 218a and 218b. The angle can vary according to the known technology in the art.

The detent 210a and 210b can be hollow. It can be molded or welled to the reed 218a and 218b. The diameter of the detent 210a and 210b can be slightly smaller than that of the holes 320a and 320b of the implement tube 304 as well as the holes 120a and 120b of the handle tube 104. The end 220a and 220b of the reed 218a and 218b can simply lean against the inner surface of the main tube 200, or can be attached to another detent. This permits the reeds 218a and 218b to be readily pulled out for repair or replacement. Thus the reeds 218a and 218b can be easily repaired and replaced or are convenient for maintenance or clean.

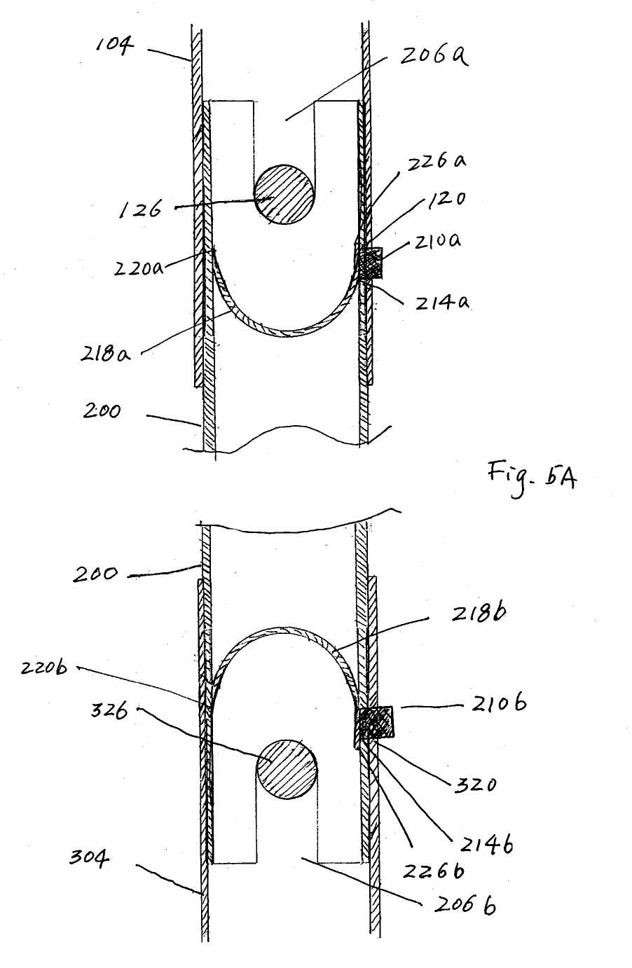

Referring to FIG. 5, an assembled tool assembly is shown. Greater details are illustrated in FIG. 5A. Slots 202a and 202b are adapted to snuggly receive corresponding shaped crossmember 126 of the handle tube and the corssmember 326 of the implement tube. The detents 210a and 210b are adapted to be fitted securely within corresponding shaped holes 120a and 120b of the handle tube and the holes 320a and 320b of the implement tube. Further, slot 202a and 202b, detent 210a and 210b, hole 120a and 120b, 320a and 320b, crossmembers 126 and 326 are so configured that when the tool assembly 18 is assembled, the crossmembers 126 and 326 snuggly sit against slots 202a and 202b while the detent 210a is firmly engaged within either of the holes 120a and 120b of the handle tube, and the detent 210b is firmly engaged within either of the holes 320a and 320b of the implement tube.

To connect the main tube 200 to the implement tube 302, a user presses the detent 210b inwardly to the inner surface of the main tube 200, insert the main tube 200 into the implement tube 304 through the upper end 303 of the implement tube 304. The user releases the detent 210b when the crossmember 326 is received snuggly within the slot 202b and the detent 210b reaches the hole 320a or 320b of the implement tube 304. The reed 218b presses the detent towards the extended position E to allow it to be secured within the hole 320a or 320b of the implement tube 304.

To separate the main tube 200 from the Implement tube 302, and user pushes the detent 2 into the main tube 200 to disengage the detent 208 from the hole 306. Then pull the main tube 200 out of the implement tube 302. The detent 208 moves back to the extended position under the pressure of the reed 216. The tool assembly can be readily assembled and disassembled without any tools. The reed 216 can be made by elastic materials know in the art, such as metal with certain strength. Same applies to the connection between the main tube 200 and the handle tube 100.

FIG. 5 shows the cross-sectional view of the assembled tool assembly in FIG. 1 along line A. The main tube 200 is firmly connected with the implement tube 304. The slots 206a and 206b snuggly respectively receive a corresponding shaped crossmembers 126 and 326 while the detent 210a is fitted securely within a corresponding shaped hole 120a or 120b, and the detent 210b is fitted securely within a corresponding shaped hole 320a or 320b.

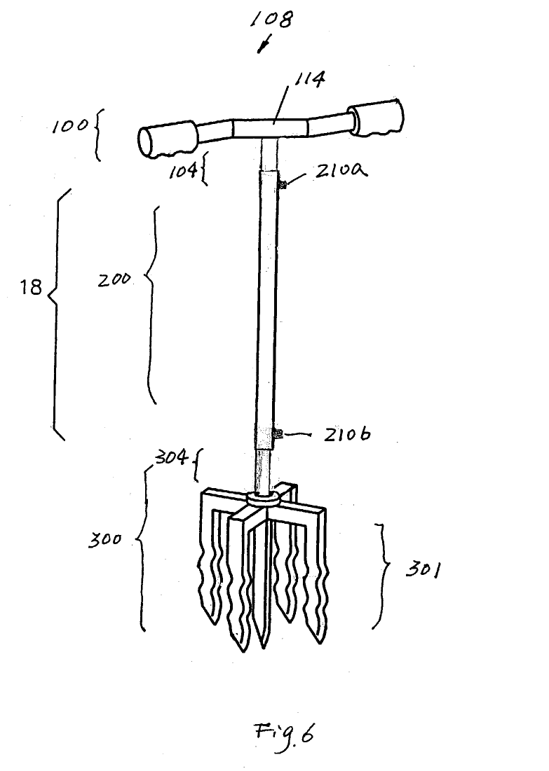

FIG. 6 and FIG. 6A show another embodiment of a tool assembly, which is reverse from the one shown in FIG. 1.

The holes 120a and 120b as well as 320a and 320b each share a common central axis 130 that is rotated, for example, 90 degrees from the central axis 330 of the crossmember 126 and 326. Thus the holes 120a, 120b are not located along the same vertical line as the connection points of the crossmember 126 on the outer surface of the handle tube 104 and the holes 320a and 320b are not located along the same vertical line as the connection points of the corssmember 326 of the implement tube 304. Further, the holes 120a and 120b are spaced apart from the crossmember 126 along the length of the handle tube 104. The holes 320a and 320b are spaced apart from the crossmemeber 326 of the implement tube along the length of the implement tube 304 respectively , i.e. the holes 120a and 120b, and the holes 320a and 320b are not positioned at the same horizontal plane as the crossmember 126 and 326 respectively. This orientation of the holes 120a, 120b and the holes 320a and 320b with the crossmembers 126 and 326 serves to distribute stresses exerted on the various components that result from a torque or a vertical force applied to the assembled tool 18 during use. Therefore, stress is spread over the handle tuber, the implement tube and the main tube vertically and horizontally, which allows these tubes to not bear excessive stress at a specific point or a local area. Same applies to the structure relating to the slot and the detent, as they are respectively adapted to a corresponding shaped and positioned crossmember or the hole. In this way, the tool assembly is provided a longer durability and maximizes the transfer of torque from the handle 100 to the tine 300.

At the same time, the connection between the crossmember and the slot as well as between the hole and the detent provide a double connection and force applying mechanism. The crossmember and the slot furnish the first connection and force-applying mechanism. A torque can be applied easily about the axis of the tube through the connection of crossmember and the slot. The hole and the detent provide a more secure connection between the two tubes as well as a force applying mechanism. In addition, the crossmember is substantially perpendicular to that of the middle section of the handle. This gives a user more leverage so as to readily apply a force, especially a torque about the central axis of the tube.

Same as the structure of the holes and the crossmembers, the detents 210a and 210b each share a common central axis 230a and 230b that is rotated, for example, 90 degrees from the central axis 240a and 240b of the slots 206a and 206b. Thus the detents 210a and 210b are not located along the same vertical line as the connection points of the slots 206a and 206b on the outer surface of the main tube 200. Further, the detents 210a and 210b are spaced apart from the slots 206a and 206b along the length of the main tube 200, i.e. the detents 210a and 210b are not positioned at the same horizontal plane as the slots 206a and 206b. This orientation of the detents 210a and 210b and the slots 206a and 206b serves to distribute stresses exerted on the various components that result from a torque or vertical force applied to the assembled tool 18 during use. Therefore, stress is spread over the tubes vertically and horizontally, which allows the tubes to not bear excessive stress at a specific point or a local area. In addition, when the crossmembers 126 and 326 rest snuggly again the slots 206a and 206b, a downward force along the main tube 200 can also be efficiently transmitted. In this way, the tool assembly is provided a longer durability and maximizes the transfer of torque from the handle 100 or a downward force along the main tube 200 to the tine 300.

The tool assembly and any of its parts can also be easily replaced or repaired by removing or detaching the components and having that components individually repaired. For example, if the handle is broken, it can be simply detached from the tool assembly 18 and replaced or repaired. The tool assembly 18 functions after a user connects the repaired or replaced handle with the rest parts. The structure can also be provided on a smaller piece that can be readily connected to an end of a corresponding shaped parts of a tool assembly. For example, the main tube can be a short tube used as a cover. A user can simply attach a cover with the crossmember and the hole to an end of a component of a tool assemble and a cover with the slot and the detent to another component. The tool assembly is assembled by connecting the parts covered by the short tubes. This provides easy connection, flexibly arrangement and easy repair or replacement.

The tool assembly can be made of metal or any other suitable materials.

### Other Emobdiments

All of the features disclosed in this specification may be combined in any combination. Each feature disclosed in this specification may be replaced by an alternative feature serving the same, equivalent, or similar purpose. Thus, unless expressly stated otherwise, each feature disclosed is only an example of a generic series of equivalent or similar features.

From the above description, one skilled in the art can easily ascertain the essential characteristics of the present invention, and without departing from the spirit and scope thereof, can make various changes and modifications of the invention to adapt it to various usages and conditions. Thus, other embodiments are also within the claims.

What is claimed is:

1. A tool assembly comprising:
a main tube having a first end, a second end, and a longitudinal axis, said main tube defining a first slot at said first end and including a first detent proximate to said slot, said first detent being movable between an extended position and a retracted position and being biased toward said extended position; and
an implement including an implement tube having a longitudinal axis, a lower end and an upper end, said upper end defining a hole and including a crossmember fixed onto an inner surface of said implement tube;
wherein said main tube and said implement tube are so configured that when said main tube is inserted into said implement tube, said first detent is secured within said hole of said implement tube and said crossmember rests against said first slot, whereby said main tube is securely connected to said implement tube.

2. The tool assembly of claim 1, wherein said crossmember has the central axis that is substantially perpendicular to that of said implement tube; said hole is spaced-apart from said crossmember along the length of said implement tube.

3. The tool assembly of claim 2, wherein said hole has a central axis that is angled from the central axis of said crossmember.

4. The tool assembly of claim 3, wherein said implement is a tine, and said main tube further defines a second slot at said second end and includes a second detent proximate to said second slot; said second detent being movable between an extended position and a retracted position, and being biased toward said extended position; said gardening tool assembly further comprising a handle, said handle having a handle tube including a lower end defining a hole and including a crossmember fixed onto an inner surface of said handle tube, wherein said main tube and said handle tube are so configured that when said main tube is inserted into said handle tube, said second detent is secured within said hole of said handle tube, said crossmember of said handle tube rests against said second slot, whereby said main tube is securely connected to said handle tube.

5. The tool assembly of claim 4, wherein the axis of said crossmember of said handle tube is substantially perpendicular to that of said handle tube; said hole of said handle tube is spaced-apart from said crossmember along the length of said handle tube.

6. The tool assembly of claim 5, wherein said hole of said handle tube has a central axis that is angled from the central axis of said crossmember of said handle tube.

7. The tool assembly of claim 5, wherein said central axis of said hole is substantially 90 degree from the central axis of said crossmember.

8. The tool assembly of claim 6, wherein said tine further having a wavy profile along the length of said tine, said wavy profile being connected to said lower end of said tine, and initially projecting outward from the longitudinal axis of said implement tube and, thereafter, extending in a direction away from said upper end of said implement tube and substantially parallel to the longitudinal axis of said implement tube.

9. The tool assembly of claim 8, wherein said handle further includes a middle section which extends outward from said main tube in two opposite directions, and two end sections extending outward from terminal ends of the middle section, each end section having a longitudinal axis, said longitudinal axes of the end sections being substantially parallel to one another and lying in a plane that is substantially perpendicular to the longitudinal axis of said handle tube, said longitudinal axis of each end section further oriented such that neither axis is substantially tangential to an arc of any imaginary circle having said upper end of said handle tube as its center and lying in said plane, wherein said two end sections of said handle extend outward from terminal ends of the middle section at obtuse angles.

10. The tool assembly of claim 9, wherein said implement tube further comprises a second hole symmetrically positioned to said crossmember as opposed to said first hole; and said handle tube further comprises a second hole symmetrically positioned to said crossmember as opposed to said first hole.

11. The tool assembly of claim 10, wherein said first hole and said second hole of said implement tube each share a central axis that is substantially perpendicular to that of said implement tube and that of said crossmember of said implement tube; and said first hole and said second hole of said handle tube each share a central axis that is perpendicular to that of said handle tube and that of said crossmember of said handle tube.

12. The tool assembly of claim 11, wherein one of said axis of said holes and said crossmembers of said handle is substantially perpendicular to said axis of said middle section of said handle.

13. The tool assembly of claim 12, wherein said crossmember of said implement tube is positioned between said first hole and said second hole, and said lower end of said implement tube; and said crossmember of said handle tube is positioned between said first hole and said second hole, and said upper end of said handle tube.

14. The tool assembly of claim 13, wherein said first detent and said second detent of said main tube each are biased by a reed, said reed having a first end connect with the inner surface of said main tube, a second end fixed onto each of said first detent or said second detent and a detent hole that the detent can readily go through when moving between said retracted and said extended position.

15. The tool assembly of claim 14, wherein said tine has a diameter that is substantially constant along a substantial length of said tine.

16. The tool assembly of claim 14, wherein the midpoint position of the diameter of said tine is substantially constant along a substantial length of said tine;

17. The tool assembly of claim 14, wherein said gardening tool assembly further comprising a plurality of tines, each connected to said lower end of said implement tube and initially projecting outward from the longitudinal axis of said implement tube and, thereafter, extending in a direction away from said upper end of said implement tube and substantially parallel to said longitudinal axis of said implement tube, at least one of said tines having a length along said longitudinal axis of said implement tube that is different than the length along the longitudinal axis of said implement tube of another tine.

18. The tool assembly of claim 17, wherein said tines project radically outward from the longitudinal axis of said implement tube;

19. The tool assembly of claim 17, wherein each tine has a length along said longitudinal axis of said implement tube that is different than the length along said longitudinal axis of said implement tube of each of the remaining tines.

20. The tool assembly of claim 17, wherein at least one of said tines has a perpendicular distance from said implement tube that is different than a perpendicular distance between said implement tube and another tine.

21. The tool assembly of claim 20 further comprising a central tine connected to the lower end of said implement tube and extending away from said upper end of said implement tube along the longitudinal axis of said implement tube.

22. The tool assembly of claim 14 further comprising a plurality of tines, each connected to said lower end of said implement tube and initially projecting outward from the longitudinal axis of said implement tube and thereafter extending in a direction away from said upper end of said implement tube and substantially parallel to the longitudinal axis of said implement tube, at least one of said tines having a perpendicular distance from said implement tube that is different than the perpendicular distance from said implement tube of another tine;

23. The tool assembly of claim 22, wherein said tines project radically outward from the longitudinal axis of said implement tube.

24. The tool assembly of claim 22, where in each tine has a perpendicular distance from said implement tube that is different than the perpendicular distance from said implement tube of each of the remaining tines.

25. The tool assembly of claim 14 further comprising a central tine connected to said lower end of said implement tube and extending away from said upper end of said implement tube along the longitudinal axis of said implement tube.

26. The tool assembly of claim 14 further comprises a base plate through which said tine is connected to said lower end of said implement tube.

27. A handle for imparting torque about the longitudinal axis of a connected tube of a tool assembly, said handle comprising:
a middle section that extends outward from said connected tube in two opposite directions,
a handle tube having:
a lower end defining a hole and further including a crossmember fixed onto an inner surface of said handle tube,
an upper end connected to said middle section, and
two end sections extending outward from terminal ends of the middle section, each end section having a longitudinal axis, said longitudinal axes of the end sections being substantially parallel to one another and lying in a plane that is substantially perpendicular to the longitudinal axis of said handle tube, said longitudinal axis of each end section further oriented such that neither is substantially tangential to an arc of any imaginary circle lying in said plane and having said upper end of said handle tube as its center, wherein said two end sections of said handle extend outward from terminal ends of the middle section at obtuse angles.

28. The handle of claim 26, wherein the axis of said crossmember is substantially perpendicular to that of said handle tube; said hole is spaced-apart from said crossmember along the length of said implement tube; said hole has a central axis that is substantially 90 degrees from the axis of said crossmember.

29. The handle of claim 28 further comprised a second hole, wherein said first hole and said second hole of said handle tube each share a central axis that is substantially perpendicular to that of said handle tube and that of said crossmember of said handle tube.

30. A handle for imparting torque about the longitudinal axis of a connected tube of a tool assembly, said handle comprising:
a middle section that extends outward from said main tube in two opposite directions;
a handle tube having:
a lower end defining a slot and including a detent proximate to said slot, said detent being moveable between an extended position and a retracted position and being biased toward said extended position,
a upper end connected to said middle section, and
two end sections extending outward from terminal ends of the middle section, each end section having a longitudinal axis, said longitudinal axes of the end sections being substantially parallel to one another and lying in a plane that is substantially perpendicular to the longitudinal axis of said handle tube, said longitudinal axis of each end section further oriented such that neither is substantially tangential to an arc of any imaginary circle lying in said plane and having said upper end of said handle tube as its center, wherein said two end sections of said handle extend outward from terminal ends of the middle section at obtuse angles.

31. The handle of claim 30, wherein said slot has a axis that is substantially perpendicular to that of said handle tube and that of said detent; and said detent is spaced-apart from said slot along the length of said handle tube.

32. A tube comprising a first end, a second end, and a longitudinal axis, said tube defining a slot at a first end and including a detent proximate to said slot; said detent being moveable between an extended position and a retracted position and being biased toward said extended position.

33. The tube of claim 32, further defines a second slot at said second end and includes a second detent proximate to said second slot; said second detent being movable between an extended position and a retracted position, and being biased toward said extended position.

34. The tube of claim 33, said first slot and said second slot each share a axis that is substantially perpendicular to that of said tube and that of said detent; and said detent is spaced-apart from said slot along the length of said handle tube; and said axis of said detent is substantially 90 degrees from that of said slot.

35. A tube comprising a first end, a second end, and a longitudinal axis, said tube defining a hole at a first end and further including a crossmember fixed onto an inner surface of said tube.

36. The tube of claim 35, wherein the axis of said crossmember is substantially perpendicular to that of said tube; said hole is spaced-apart from said crossmember along the length of said tube.

37. The tube of claim 36, further defines a second hole at said second end and includes a second crossmember fixed onto an inner surface of said tube; wherein and said first hole and said second hole each share a central axis perpendicular to that of said tube and that of said first crossmemeber and said second crossmember of said tube; said second hole are spaced-apart from said crossmember along the length of said tube; and said second crossmember has a central axis that is substantially perpendicular to that of said tube.

38. An implement of a tool assembly comprising:
an implement tube having a lower end and an upper end, said upper end defining a hole and further including a crossmember fixed onto an inner surface of said implement tube;
wherein the axis of said crossmember is substantially perpendicular to that of said implement tube; said hole is spaced-apart from said crossmember along the length of said implement tube.

39. The implement of claim 38, further defines a second hole at said second end and includes a second crossmember fixed onto an inner surface of said tube; wherein and said first hole and said second hole each share a central axis perpendicular to that of said implement tube and that of said crossmember of said implement tube; said second hole are spaced-apart from said crossmember along the length of said tube.

40. The implement of claim 39, said implement is a tine having a wavy profile along the length of said tine, said wavy profile being connected to said lower end of said implement tube, and initially projecting outward from the longitudinal axis of said implement tube and, thereafter, extending in a direction away from said upper end of said implement tube and substantially parallel to the longitudinal axis of said implement tube.

41. An implement of a tool assembly comprising:
an implement tube having a lower end and an upper end, said upper end defining a detent proximate to said slot, said detent being moveable between an extended position and a retracted position, and being biased toward said extended position;
wherein the axis of said crossmember is substantially perpendicular to that of said implement tube; said hole is spaced-apart from said crossmember along the length of said implement tube; and said hole has a central axis that is angled from the axis of said crossmember.

42. The implement of claim 41, wherein the implement tube further defines a second slot at said second end and a second detent proximate to said second slot, said second detent being moveable between an extended position and a retracted position, and being biased toward said extended position; said first detent and said second detent each share a central axis; said first slot and said second slot each share a central axis; said central axis of said first detent and said second detent is substantially perpendicular to that of said first slot and said second slot and that of the implement tube; said first and second detent are spaced-apart from said crossmember along the length of said tube.

43. The implement of claim 42, wherein said implement is a tine having a wavy profile along the length of said tine, said wavy profile being connected to said lower end of said implement tube, and initially projecting outward from the longitudinal axis of said implement tube and, thereafter, extending in a direction away from said upper end of said implement tube and substantially parallel to the longitudinal axis of said implement tube.

44. A tool assembly comprising:
a main tube having a first end, a second end, and a longitudinal axis, said main tube defining a first hole at said first end and -a second hole at said second end and further including a first crossmember fixed onto the inner surface of said main tube,
a tine including a tine tube having a lower end and an upper end, said upper end defining a slot and including a detent proximate to said slot, said detent being movable between an extended position and a retracted position, and being biased towards said extended position, and
a handle including a handle tube having a lower end and an upper end, said lower end defining a slot and including a detent proximate to said slot, said detent being movable between an extended position and a retracted position, and being biased towards said extended position;
wherein said main tube, said implement tube and said handle tube are so configured that when said tine tube and said handle tube are inserted into said main tube, said detents of said tine tube and said handle tube are secured within said first hole and said second hole of said main tube respectively, and said first crossmember and said second crossmember of said main tube rest against said slots of said tine tube and said handle tube respectively, whereby said main tube is securely connected to said implement tube and said handle tube.

45. The tool assembly of claim 44, wherein said crossmember has a central axis that is substantially perpendicular to that of said main tube; said first hole and said second hole are spaced-apart from said crossmember along the length of said main tube; said first hole and said second hole each share a central axis that is substantially perpendicular to the axis of said main tube and said crossmember.

46. The tool assembly of claim 45, wherein said first detent and said second detent of said implement tube each share a central axis; said first slot and said second slot of said implement tube each share a central axis; said central axis of said first detent and said second detent is substantially perpendicular to that of said first slot and said second slot of said implement tube and that of said implement tube; and said first detent and said second detent of said handle tube each share a central axis; said first slot and said second slot of said handle tube each share a central axis; said central axis of said first detent and said second detent is substantially perpendicular to that of said first slot and said second slot of said handle tube and that of said handle tube.
